(19) United States
(12) Patent Application Publication
(10) Pub. No.: US 2013/0141572 A1
(43) Pub. Date: Jun. 6, 2013

(54) VEHICLE MONITORING SYSTEM FOR USE WITH A VEHICLE

(71) Applicants: Alex Laton Torres, Hillister, TX (US); Travis Lee Torres, Hillister, TX (US)

(72) Inventors: Alex Laton Torres, Hillister, TX (US); Travis Lee Torres, Hillister, TX (US)

(21) Appl. No.: 13/311,510

(22) Filed: Dec. 5, 2011

(51) Int. Cl. H04N 7/18

(52) U.S. Cl. 348/143; 348/E07.085

(57) ABSTRACT

Vehicle monitoring systems for use with a vehicle are disclosed. Vehicles have cargo and non-cargo regions, the non-cargo regions including an engine compartment and an undercarriage. Embodiments of vehicle monitoring systems may include cameras configured in the non-cargo regions to capture images of the non-cargo regions. A data processing system may be mounted to the vehicle. The data processing system may be operatively connected to the cameras. The data processing system may include at least one processor, at least one memory, and at least one transmitter operatively connected together for: receiving captured images from the cameras; recording the captured images in non-volatile memory configured in the vehicle; and transmitting the captured images to remote storage away from the vehicle. Other vehicle monitoring systems may incorporate and synchronize performance metrics with the captured images.

### BACKGROUND OF THE INVENTION

The field of the invention is data processing, or, more specifically, vehicle monitoring systems for use with a vehicle.

### SUMMARY OF THE INVENTION

Vehicle monitoring systems according to the present invention for use with a vehicle are generally disclosed. A vehicle has a cargo and non-cargo regions. The non-cargo regions include an engine compartment and an undercarriage. One or more cameras may be configured in the non-cargo regions to capture images of the non-cargo regions. One or more microphones may be configured in the non-cargo regions to capture audio of the non-cargo regions. A data processing system operatively connected to the cameras and the microphones may be mounted to the vehicle. The data processing system includes at least one processor, at least one memory, and at least one transmitter operatively connected together for: receiving captured images and audio from the cameras; recording the captured images and audio in non-volatile memory configured in the vehicle; and transmitting the captured images and audio to remote storage away from the vehicle.

In other vehicle monitoring systems according to the present invention, one or more cameras may be configured in the non-cargo regions to capture images of the non-cargo regions. The cameras may record the captured images in non-volatile memory configured in the cameras. The data processing system operatively connected to the cameras may operate by: receiving captured images from the cameras; and transmitting the captured images to remote storage away from the vehicle.

In still other vehicle monitoring systems according to the present invention, one or more cameras may be configured in the non-cargo regions to capture images of the non-cargo regions. One or more sensors may be configured in the vehicle for capturing performance metrics of the vehicle. The data processing system may be operatively connected to the cameras and the sensors and operate for: receiving captured images from the cameras for a time period; receiving performance metrics from the sensors for the time period; synchronizing the captured images and the performance metrics; and administering the synchronized captured images and performance metrics in dependence upon administration criteria.

Still further, in other vehicle monitoring systems according to the present invention, one or more cameras configured in the non-cargo regions to capture images of the non-cargo regions. The data processing system operatively connected to the cameras may operate for: receiving captured images from the cameras; recording the captured images in non-volatile memory configured in the vehicle; and transmitting the captured images to remote storage away from the vehicle.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary vehicle monitoring system for use with a vehicle according to embodiments of the present invention.

FIG. 2 sets forth a block diagram of automated computing machinery comprising an example of a data processing system useful in a vehicle monitoring system for use with a vehicle according to embodiments of the present invention.

FIG. 3 sets forth a flow chart illustrating operation of an exemplary vehicle monitoring system for use with a vehicle according to embodiments of the present invention.

FIG. 4 sets forth a flow chart illustrating operation of an exemplary vehicle monitoring system for use with a vehicle according to embodiments of the present invention.

FIG. 5 sets forth a flow chart illustrating operation of an exemplary vehicle monitoring system for use with a vehicle according to embodiments of the present invention.

FIG. 6 sets forth a flow chart illustrating operation of an exemplary vehicle monitoring system for use with a vehicle according to embodiments of the present invention.

FIG. 7 sets forth a flow chart illustrating operation of an exemplary vehicle monitoring system for use with a vehicle according to embodiments of the present invention.

FIG. 8 sets forth a flow chart illustrating operation of an exemplary vehicle monitoring system for use with a vehicle according to embodiments of the present invention.

FIG. 9 sets forth a flow chart illustrating operation of an exemplary vehicle monitoring system for use with a vehicle according to embodiments of the present invention.

FIGS. 10A-C set forth exemplary videos comprising exemplary image data for use with an exemplary vehicle monitoring system according to embodiments of the present invention.

FIG. 11 sets forth a flow chart illustrating operation of an exemplary vehicle monitoring system for use with a vehicle according to embodiments of the present invention.

### DETAILED DESCRIPTION OF EXEMPLARY EMBODIMENTS

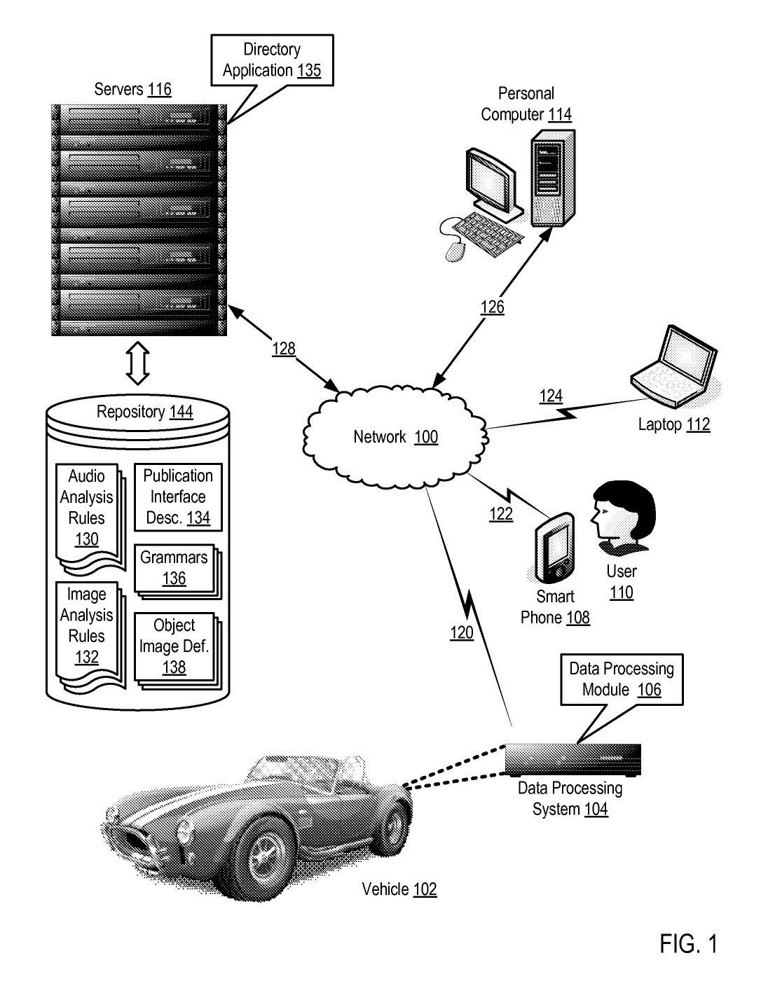

Exemplary vehicle monitoring systems for use with a vehicle according to embodiments of the present invention are described with reference to the accompanying drawings, beginning with FIG. 1. FIG. 1 sets forth a network diagram illustrating an exemplary vehicle monitoring system for use with a vehicle according to embodiments of the present invention.

The exemplary system of FIG. 1 includes a vehicle (102) with which the exemplary vehicle monitoring system of FIG. 1 may be used. A vehicle is a device that is designed or used to transport cargo, such as people or goods. People transported using vehicles are often referred to as “passengers.” Examples of vehicles that may be used in vehicle monitoring systems according to embodiments of the present invention include bicycles, cars, trucks, motorcycles, trains, ships, boats, hovercraft, aircraft, or any other device for transporting one or more people as will occur to those of skill in the art. Vehicles that do not travel on land often are referred to as “crafts,” such as watercraft, sailcraft, aircraft, hovercraft, and spacecraft.

The vehicle (102) of FIG. 1 has cargo and non-cargo regions. Cargo generally refers to items or persons being transported by a vehicle. Cargo regions specify areas designated for stowing items for transport or areas designated for people to ride while being transported. Cargo regions, therefore, may include, for example, a passenger cabin of car or truck. Other examples may include a deck of a boat or a cabin of a ship. Non-cargo regions generally refer to the other areas of a vehicle. Non-cargo regions include an engine compartment and an undercarriage and may include other areas of a vehicle housing engine systems, control systems, air-conditioning systems, safety systems, navigational systems, or the like.

The vehicle monitoring system of FIG. 1 for use with a vehicle according to embodiments of the present invention includes one or more cameras (not shown in FIG. 1) configured in the non-cargo regions of the vehicle (102) of FIG. 1 to capture images of the non-cargo regions. The cameras are not shown in FIG. 1 because these cameras in this example are mounted in places not typically visible when viewing the vehicle (102) externally under typical circumstances. Rather, these cameras are mounted under the hood in the engine compartment and along the undercarriage of the exemplary vehicle (102) of FIG. 1. The cameras may be permanently installed in the vehicle or removeably attached to the vehicle.

The cameras installed in the vehicle (102) of FIG. 1 may capture still images and/or video. In addition, the cameras may have built-in microphones to capture audio as well. Image formats that may be useful in vehicle monitoring systems according to embodiments of the present invention may include JPEG (Joint Photographic Experts Group), JFIF (JPEG File Interchange Format), JPEG 2000, Exif (Exchangeable image file format), TIFF (Tagged Image File Format), RAW, PNG (Portable Network Graphics), GIF (Graphics Interchange Format), BMP (Bitmap), PPM (Portable Pixmap), PGM (Portable Graymap), PBM (Portable Bitmap), PNM (Portable Any Map), WEBP (Google's lossy compression image format based on VP8's intra-frame coding and uses a container based on RIFF), CGM (Computer Graphics Metafile), Gerber Format (RS-274X), SVG (Scalable Vector Graphics), PNS (PNG Stereo), and JPS (JPEG Stereo), or any other image format as will occur to those of skill in the art. Similarly, video formats that may be useful in vehicle monitoring systems according to embodiments of the present invention may include MPEG (Moving Picture Experts Group), H.264, WMV (Windows Media Video), Schrödinger, dirac-research, VPx series of formats developed by On2 Technologies, RealVideo), or any other format format as will occur to those of skill in the art. Some stand-alone audio formats that may be useful in vehicle monitoring systems according to embodiments of the present invention may include AIFF (Audio Interchange File Format), WAV (Microsoft WAVE), ALAC (Apple Lossless Audio Codec), MPEG (Moving Picture Experts Group), FLAC (Free Lossless Audio Codec), RealAudio, G.719, G.722, WMA (Windows Media Audio), and these codecs especially suitable for capturing speech, AMBE (Advanced Multi-Band Excitation), ACELP (Algebraic Code Excited Linear Prediction), DSS (Digital Speech Standard), G.711, G.718, G.726, G.728, G.729, HVXC (Harmonic Vector Excitation Coding), Truespeech, or any other audio format as will occur to those of skill in the art.

The cameras mounted in the vehicle (102) of FIG. 1 include a communications sub-system that allow the camera to export the image, video, and/or audio information to another device or system. The cameras may also include built-in memory to store the image, video, and/or audio information in the camera itself until such information is downloaded into another device or a user deletes the information stored in the camera.

The vehicle monitoring system of FIG. 1 for use with a vehicle according to embodiments of the present invention includes a data processing system (104) mounted to the vehicle (102). A data processing system generally refers to automated computing machinery. The data processing system (104) of FIG. 1 is mounted to the vehicle (102) in a manner to prevent it from being tossed or pushed around during travel, but the data processing system (104) may be mounted in a manner to allow it to be easily removed from vehicle and taken with a user. In other embodiments, however, such as in the example of FIG. 1, the data processing system (104) is permanently installed in the vehicle (102).

A data processing system useful in vehicle monitoring systems according to embodiments of the present invention may be configured in a variety of form factors or implemented using a variety of technologies. Some data processing systems may be implemented using single-purpose computing machinery, such as special-purpose computers programmed only for the task of data processing for vehicle monitoring systems according to embodiments of the present invention. Single-purpose computing machinery is more likely to be permanently installed in a vehicle, such as in the embodiment of FIG. 1. Other data processing systems may be implemented using multi-purpose computing machinery, such as general purpose computers programmed for a variety of data processing functions in addition to vehicle monitoring systems according to embodiments of the present invention. These multi-purpose computing devices may be implemented as portable computers, laptops, personal digital assistants, tablet computing devices, multi-functional portable phones, or the like.

In the example of FIG. 1, the data processing system (104) includes at least one processor, at least one memory, and at least one transmitter, all operatively connected together, typically through a communications bus. The transmitter is a wireless transmitter that connects the data processing system (104) to the network (100) through a wireless connection (120). The transmitter may use a variety of technologies, alone or in combination, to establish wireless connection (120) with network (100) including, for example, Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), Integrated Digital Enhanced Network (iDEN), IEEE 802.11 technology, Bluetooth, WiGig, WiMax, Iridium satellite communications technology, Globalstar satellite communications technology, or any other wireless communications technology as will occur to those of skill in the art.

The data processing system (104) of FIG. 1 is also operatively connected to the cameras installed in the vehicle. This operative connection between the data processing system (104) and the camera in the vehicle (102) may be implemented as wired or wireless connection using any of a variety of communications technology as will occur to those of skill in the art, including, Bluetooth, IEEE 802.11, Universal Serial Bus, JTAG (Joint Test Action Group), Separate Video, Composite Video, Component Video, or any other communications technology as will occur to those of skill in the art. Readers will note that depending on the implementation of the operative connection between data processing system (104) and the cameras, the video, image, and/or audio data may be communicated in-bound or out-of-bound with the control signals. For example, using USB or Bluetooth technology, data signals and control signals between the data processing system (104) and cameras travel through the same communications medium. But using, Separate Video, Composite Video, or Component Video to communicate video, image, and/or audio information requires the use of a separate control channel between the data processing system (104) and the cameras, which may be implemented using a separate JTAG network or using Bluetooth or USB data communications to control the cameras.

A memory included in the data processing system (104) of FIG. 1 includes a data processing module (106). The data processing module (106) of FIG. 1 is a set of computer program instructions for monitoring a vehicle according to embodiments of the present invention. When processing the data processing module (106) of FIG. 1, a processor may operate the data processing system (104) of FIG. 1 to: receive captured images from the cameras; record the captured images in non-volatile memory configured in the vehicle (102); and transmit the captured images to remote storage away from the vehicle (102).

Non-volatile memory is computer memory that can retain the stored information even when no power is being supplied to the memory. The non-volatile memory may be part of the data processing system (104) of FIG. 1 or may be a separate storage device operatively coupled to the data processing system (104). Examples of non-volatile memory include flash memory, ferroelectric RAM, magnetoresistive RAM, hard disks, magnetic tape, optical discs, and others as will occur to those of skill in the art.

As previously mentioned, cameras installed in the vehicle (102) of FIG. 1 may include their own non-volatile memory storage, which may make having the data processing system (104) store the captured images unnecessarily redundant. Accordingly, the data processing module (106) of FIG. 1 may include computer program instructions that leave out instructions directing the data processing system (104) to record the captured images in non-volatile memory configured in the vehicle (102). In this manner, the data processing module (106) of FIG. 1 may include computer program instructions that when processed only direct a processor to operate the data processing system (104) of FIG. 1 to: receive captured images from the cameras; and transmit the captured images to remote storage away from the vehicle (102).

In addition to the cameras, the vehicle (102) of FIG. 1 includes one or more sensors configured in the vehicle for capturing performance metrics of the vehicle. Each sensor is a device that measures a physical quantity and converts it to a signal which can be manipulated by a data processing system. These signals captured by sensors are generally referred to as performance metrics. Sensors may be used to measure a variety of aspects of the vehicle (102) in FIG. 1 including temperature, torque, rotations per minute, pressure, voltage, current, and the like.

In some embodiments of the present invention, the images captured from the cameras are combined with the performance metrics captured by the sensors. In this manner, the data processing module (106) of FIG. 1 may include computer program instructions that when processed direct a processor to operate the data processing system (104) of FIG. 1 to: receive captured images from the cameras for a time period; receive performance metrics from the sensors for the same time period; synchronize the captured images and the performance metrics; and administer the synchronized captured images and performance metrics in dependence upon administration criteria, which may include a combination of storing the synchronized captured images and performance metrics locally at the vehicle (102) or transmitting the synchronized captured images and performance metrics to remote storage.

Because the data processing system (104) of FIG. 1 is connected to the network (100), the data processing system (104) of FIG. 1 may communicate with other devices connected to the network (100). In the example of FIG. 1, for example, smart phone (108) operated by user (110) connects to the network (100) via wireless connection (122), laptop (112) connects to network (100) via wireless connection (124), personal computer (114) connects to network (100) through wireline connection (126), and servers (116) connect to the network (100) through wireline connection (128). Any of these other devices (108,112, 114, 116) may include remote storage to which the data processing system (104) of FIG. 1 transmits the captured images or the synchronized captured images and performance metrics away from the vehicle (102).

In the example of FIG. 1, servers (116) host a repository (144) of information that may be useful in vehicle monitoring systems according to embodiments of the present invention. Repository (144) of FIG. 1 stores audio analysis rules (130), image analysis rules (132), grammars (136), and object image definitions (138) that may be useful for vehicle monitoring systems respond to certain image and audio analysis of the image and audio data capture by the cameras in the vehicle (102).

These various audio analysis rules (130), image analysis rules (132), grammars (136), and object image definitions (138) may be used by the data processing system (104) of FIG. 1 to analyze captured images or audio in ways that may be useful for monitoring a vehicle according to embodiments of the present invention. For example, the audio analysis rules (130) and grammars (136) may allow the data processing system (104) to identify certain words or phrases being uttered by persons working on the vehicle (102) at a service facility and take certain actions based on the identified words or phrases. If the data processing system (104) of FIG. 1 identifies a curse words being uttered by a service technician, the data processing system (104) of FIG. 1 may begin capturing images from the cameras installed on the vehicle (102) to ensure that any malfeasance is being captured on video. Similarly, image analysis rules (132) and object image definitions (138) may be used to identify certain items recorded on video and alert the owner of the vehicle (102) with an email or text message. Items that may be of interest to the owner of the vehicle (102) may include any tools such as knives, torches, etc. that would not be used in a routine oil change service.

The audio analysis rules (130) of FIG. 1 specify certain actions to be taken by the data processing module (104) when certain words or phrases are identified by the data processing module (104). For example, consider the exemplary Table 1 below identifying several exemplary audio analysis rules:

TABLE 1

| PHRASE | ACTION PROCEDURE |
|---|---|
| . . . | . . . |
| “destroy” | beginImageCapture( ); |
| “oh crap” | beginImageCapture( ); |
| “hurry before anyone sees” | beginImageCapture( ); |
| . . . | . . . |

Each row in Table 1 represents an exemplary audio analysis rule useful in vehicle monitoring systems according to embodiments of the present invention. In Table 1, the exemplary audio analysis rules instruct the data processing system (104) of FIG. 1 to call the “beginImageCapture( )” procedure when the data processing system (104) recognizes the word “destroy” or the phrases “oh crap” or “hurry before anyone sees” being uttered. The “beginImageCapture( )” procedure contains a set of computer program instructions that causes the data processing system (104) to begin capturing images and recording them to non-volatile memory and/or transmitting those capture images to remote storage away from the vehicle (102). Readers will note that the audio analysis rules in Table 1 are for example only and not for limitation. Other exemplary audio analysis rules stored in other formats may also be useful in vehicle monitoring systems according to embodiments of the present invention.

The data processing system (104) of FIG. 1 uses grammars (136), in conjunction with speech engines, to identify certain words or phrases utter by individuals and captured by various microphones embedded into the cameras of the vehicle (102) or installed separately. A speech engine is a functional module, typically a software module, although it may include specialized hardware also, that does the work of recognizing or generating or ‘synthesizing’ human speech. The speech engine implements speech recognition by use of a further module referred to in this specification as an automated speech recognition (‘ASR’) engine.

The grammars (136) of FIG. 1 communicate to the speech engine the words and sequences of words eligible for speech recognition during the interactions between individuals and the data processing system (104). Grammars useful in vehicle monitoring systems according to embodiments of the present invention may be expressed in any format supported by any speech engine, including, for example, the Java Speech Grammar Format (‘JSGF’), the format of the W3C Speech Recognition Grammar Specification (‘SRGS’), the Augmented Backus-Naur Format (‘ABNF’) from the IETF's RFC2234, in the form of a stochastic grammar as described in the W3C's Stochastic Language Models (N-Gram) Specification, and in other grammar formats as may occur to those of skill in the art. Here is an example of a grammar expressed in JSFG:

<grammar scope=“dialog” ><![CDATA[

#JSGF V1.0;
grammar command;
<command> = [remind me to] call | phone | telephone <name>
<when>;
<name> = bob | martha | joe | pete | chris | john | artoush | tom;
<when> = today | this afternoon | tomorrow | next week;
]]>

</grammar>

In this example, the elements named <command>, <name>, and <when> are rules of the grammar. Rules are a combination of a rule name and an expansion of a rule that advises a speech engine or a voice interpreter which words presently can be recognized. In this example, expansion includes conjunction and disjunction, and the vertical bars ‘|’ mean ‘or.’ A speech engine or a voice interpreter processes the rules in sequence, first <command>, then <name>, then <when>. The <command> rule accepts for recognition ‘call’ or ‘phone’ or ‘telephone’ plus, that is, in conjunction with, whatever is returned from the <name> rule and the <when> rule. The <name> rule accepts ‘bob’ or ‘martha’ or ‘joe’ or ‘pete’ or ‘chris’ or ‘john’ or ‘artoush’ or ‘tom’, and the <when> rule accepts ‘today’ or ‘this afternoon’ or ‘tomorrow’ or ‘next week.’ The command grammar as a whole matches utterances like these, for example:
“phone bob next week,”
“telephone martha this afternoon,”
“remind me to call chris tomorrow,” and
“remind me to phone pete today.”

In this manner, grammars (136) may be useful to assist the data processing system (104) to recognize more complex phrases than single words.

Similarly, the image analysis rules (132) of FIG. 1 specify certain actions to be taken by the data processing module (104) when images of certain items are identified by the data processing module (104). For example, consider the exemplary Table 2 below identifying several exemplary image analysis rules:

TABLE 2

| IMAGE IDENTIFIER | ACTION PROCEDURE |
|---|---|
| . . . | . . . |
| knife | beginImageCapture( ); |
| torch | beginImageCapture( ); |
| wire | beginImageCapture( ); |
| . . . | . . . |

Each row in Table 2 represents an exemplary image analysis rule useful in vehicle monitoring systems according to embodiments of the present invention when a service facility is performing a routine oil change. Different sets of image analysis rules may be used based on the selection of the vehicle's owner. For example, the data processing system (104) may utilize one set of image analysis rules when the vehicle undergoes a routine oil change and another set of image analysis rules when the vehicle undergoes an engine replacement. Turning back to Table 2, Table 2 specifies a set of exemplary image analysis rules when a service facility is performing a routine oil change. The exemplary image analysis rules in Table 2 instruct the data processing system (104) of FIG. 1 to call the “beginImageCapture( )” procedure when the data processing system (104) recognizes the any of the following images: knife, torch, or wire, ostensibly because such tools are not normally used when a technician performs a routine oil change. Turning on the image capture capabilities might allow the owner of the vehicle to capture evidence of malfeasance of behalf of the service facility or its employees. Readers will note that the image analysis rules in Table 2 are for example only and not for limitation. Other exemplary image analysis rules stored in other formats may also be useful in vehicle monitoring systems according to embodiments of the present invention.

The data processing system (104) of FIG. 1 uses object image definitions (138) to recognize images of various items captured by the cameras in the vehicles (102). Each item that requires recognition may have one or more object image definitions (138). Each object image definition (138) of FIG. 1 may specify certain characteristics for a particular item that the data processing system (104) can compare with the capture images or identify in the captured images to determine with a high level of probability that the capture images contains a particular items. Using object image definitions (138) in the example of FIG. 1, however, is for explanation only, not for limitation. There are many different techniques that may be used in analyzing images. Some techniques are more suitable for some applications, while other techniques are suitable for other applications. Vehicle monitoring systems useful in embodiments of the present invention may still further use multiple techniques. Examples of image analysis techniques may include 2D and 3D object recognition, image segmentation, motion detection (e.g. single particle tracking), video tracking, optical flow, medical scan analysis, 3D Pose Estimation, automatic number plate recognition, and so on.

In the example of FIG. 1, the repository (144) stores audio analysis rules (130), image analysis rules (132), grammars (136), and object image definitions (138) that may be useful for vehicle monitoring systems respond to certain image and audio analysis of the image and audio data capture by the cameras in the vehicle (102). Readers will understand that copies of such items may also be stored locally with the data processing system (104). While data processing system (104) of FIG. 1 may store these items locally, the repository (144) may store a greater variety that extends the analysis capabilities of the data processing system (104).

The data processing system (104) of FIG. 1 interacts with the repository (144) using a publication interface description (134) and a directory application (135). The directory application (135) of FIG. 1 provides the description (134) of the web services publication interface by publishing the web services publication interface description (134) in a Universal Description, Discovery and Integration (‘UDDI’) registry hosted by a UDDI server. A UDDI registry is a platform-independent, XML-based registry for organizations worldwide to list themselves on the Internet. UDDI is an open industry initiative promulgated by the Organization for the Advancement of Structured Information Standards (‘OASIS’), enabling organizations to publish service listings, discover each other, and define how the services or software applications interact over the Internet. The UDDI registry is designed to be interrogated by SOAP messages and to provide access to Web Services Description Language (‘WSDL’) documents describing the protocol bindings and message formats required to interact with a web service listed in the UDDI registry. In this manner, the data processing system (104) of FIG. 1 may retrieve the web services publication interface description (134) for the audio analysis rules (130), images analysis rules (132), grammars (136), and object image definitions (138) from the UDDI registry on the server (116). The term ‘SOAP’ refers to a protocol promulgated by the World Wide Web Consortium (‘W3C’) for exchanging XML-based messages over computer networks, typically using Hypertext Transfer Protocol (‘HTTP’) or Secure HTTP (‘HTTPS’).

In the example of FIG. 1, the web services publication interface description (116) of FIG. 1 may be implemented as a Web Services Description Language (‘WSDL’) document. The WSDL specification provides a model for describing a web service's interface as collections of network endpoints, or ports. A port is defined by associating a network address with a reusable binding, and a collection of ports define a service. Messages in a WSDL document are abstract descriptions of the data being exchanged, and port types are abstract collections of supported operations. The concrete protocol and data format specifications for a particular port type constitutes a reusable binding, where the messages and operations are then bound to a concrete network protocol and message format. In such a manner, the data processing system (104) or other similar systems may utilize the web services publication interface description (134) to invoke the publication service provided by the directory application (135), typically by exchanging SOAP messages with the directory application (135). The directory application (135) of FIG. 1 may be implemented using Java, C, C++, C#, Perl, or any other programming language as will occur to those of skill in the art.

The exemplary system of FIG. 1, audio analysis rules (130), image analysis rules (132), grammars (136), and object image definitions (138) are stored in a repository (144) operatively coupled to the directory application (135). The repository (144) may be implemented as a database stored locally on the servers (116) or remotely stored and accessed through a network. The directory application (135) may be operatively coupled to such an exemplary repository through an application programming interface (‘API’) exposed by a database management system (‘DBMS’) such as, for example, an API provided by the Open Database Connectivity (‘ODBC’) specification, the Java database connectivity (‘JDBC’) specification, and so on.

In the example of FIG. 1, all of the servers and devices are connected together through a communications network (100), which in turn may be composed of many different networks. These different networks may be packet switched networks or circuit switched networks, or a combination thereof, and may be implemented using wired, wireless, optical, magnetic connections, or using other mediums as will occur to those of skill in the art. Typically, circuit switch networks connect to packet switch networks through gateways that provide translation between protocols used in the circuit switch network such as, for example, PSTN-V5 and protocols used in the packet switch networks such as, for example, SIP.

The packet switched networks, which may be used to implement network (100) in FIG. 1, are composed of a plurality of computers that function as data communications routers, switches, or gateways connected for data communications with packet switching protocols. Such packet switched networks may be implemented with optical connections, wireline connections, or with wireless connections or other such connections as will occur to those of skill in the art. Such a data communications network may include intranets, internets, local area data communications networks (‘LANs’), and wide area data communications networks (‘WANs’). Such packet switched networks may implement, for example:
a link layer with the Ethernet™ Protocol or the Wireless Ethernet™ Protocol,
a data communications network layer with the Internet Protocol (‘IP’),
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The circuit switched networks, which may be used to implement network (100) in FIG. 1, are composed of a plurality of devices that function as exchange components, switches, antennas, base stations components, and connected for communications in a circuit switched network. Such circuit switched networks may be implemented with optical connections, wireline connections, or with wireless connections. Such circuit switched networks may implement the V5.1 and V5.2 protocols along with other as will occur to those of skill in the art.

The arrangement of the devices (104, 108, 112, 114, 116) and the network (100) making up the exemplary system illustrated in FIG. 1 are for explanation, not for limitation. Systems useful for vehicle monitoring systems according to various embodiments of the present invention may include additional networks, servers, routers, switches, gateways, other devices, and peer-to-peer architectures or others, not shown in FIG. 1, as will occur to those of skill in the art. Networks in such data processing systems may support many protocols in addition to those noted above. Various embodiments of the present invention may be implemented on a variety of hardware platforms in addition to those illustrated in FIG. 1.

Vehicle monitoring systems according to embodiments of the present invention may be implemented with one or more computers, that is, automated computing machinery, along with camera and sensors.

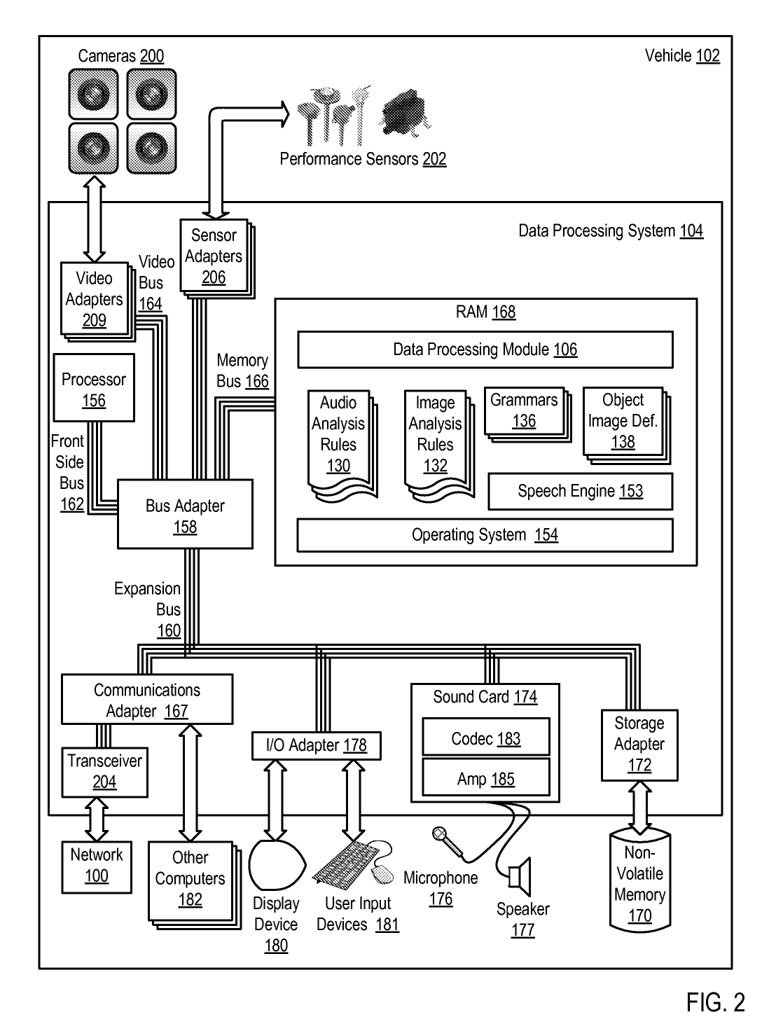

For further explanation, therefore, FIG. 2 sets forth a block diagram of automated computing machinery comprising an example of a data processing system (104) for use in an exemplary vehicle monitoring system according to embodiments of the present invention. The data processing system (104) of FIG. 2 includes at least one processor (156) or ‘CPU’ as well as random access memory (168) (‘RAM’) which is connected through a high speed memory bus (166) and bus adapter (158) to processor (156) and to other components of the data processing system (104).

Stored in RAM (168) of FIG. 2 is a data processing module (106) that is a set of computer programs that monitors a vehicle according to embodiments of the present invention. The data processing module (106) of FIG. 2 operates in a manner similar to the manner described with reference to FIG. 1. In at least one exemplary configuration, the data processing module (106) of FIG. 2 instructs the processor (156) of the data processing system (104) to: receive captured images from the cameras (200); record the captured images in non-volatile memory (170) configured in the vehicle (102); and transmit the captured images to remote storage away from the vehicle.

As previously mentioned, cameras (200) installed in the vehicle (102) of FIG. 2 may include their own non-volatile memory storage, which may make having the data processing system (104) store the captured images unnecessarily redundant. Accordingly, the data processing module (106) of FIG. 2 may include computer program instructions that leave out instructions directing the data processing system (104) to record the captured images in non-volatile memory (170) configured in the vehicle (102). In this manner, the data processing module (106) of FIG. 1 may include computer program instructions that when processed direct a processor (156) to operate the data processing system (104) of FIG. 2 to: receive captured images from the cameras (200); and transmit the captured images to remote storage away from the vehicle (102).

In addition to the cameras (200), the vehicle (102) of FIG. 2 includes one or more performance sensors (202) configured in the vehicle for capturing performance metrics of the vehicle. The performance sensors connect to the data processing system (104) through sensor adapters (208) and bus adapter (158). As mentioned above, each sensor is a device that measures a physical quantity and converts it to a signal which can be manipulated by a data processing system. These signals captured by sensors are generally referred to as performance metrics. Sensors may be used to measure a variety of aspects of the vehicle (102) in FIG. 2 including temperature, torque, rotations per minute, pressure, voltage, current, and the like.

In some embodiments of the present invention, the images captured from the cameras are combined with the performance metrics captured by the sensors. In this manner, the data processing module (106) of FIG. 2 may include computer program instructions that when processed direct the processor (156) to operate the data processing system (104) of FIG. 2 to: receive captured images from the cameras (200) for a time period; receive performance metrics from the sensors (202) for the same time period; synchronize the captured images and the performance metrics; and administer the synchronized captured images and performance metrics in dependence upon administration criteria, which may include a combination of storing the synchronized captured images and performance metrics locally at the vehicle (102) in non-volatile memory (170) or transmitting the synchronized captured images and performance metrics to remote storage.

Also stored in RAM (168) are audio analysis rules (130), image analysis rules (132), grammars (136), object image definitions (138), and a speech engine (153). The audio analysis rules (130), image analysis rules (132), grammars (136), and object image definitions (138) of FIG. 2 are similar to those same components described with respect to FIG. 1.

The speech engine (153) of FIG. 2 is a functional module, typically a software module, although it may include specialized hardware also, that does the work of recognizing and generating human speech. The speech engine (153) includes an ASR engine for speech recognition and may include a text-to-speech (‘TTS’) engine for generating speech. The speech engine also uses grammars (136), as well as lexicons and language-specific acoustic models.

An acoustic model associates speech waveform data representing recorded pronunciations of speech with textual representations of those pronunciations, which are referred to as ‘phonemes.’ The speech waveform data may be implemented as a Speech Feature Vector (‘SFV’) that may be represented, for example, by the first twelve or thirteen Fourier or frequency domain components of a sample of digitized speech waveform. Accordingly, the acoustic models may be implemented as data structures or tables in a database, for example, that associates these SFVs with phonemes representing, to the extent that it is practically feasible to do so, all pronunciations of all the words in various human languages, each language having a separate acoustic model. The lexicons are associations of words in text form with phonemes representing pronunciations of each word; the lexicon effectively identifies words that are capable of recognition by an ASR engine. Each language has a separate lexicon.

The grammars (136) of FIG. 2 communicate to the ASR engine of the speech engine (153) the words and sequences of words that currently may be recognized. For precise understanding, readers will distinguish the purpose of the grammar and the purpose of the lexicon. The lexicon associates with phonemes all the words that the ASR engine can recognize. The grammar communicates the words currently eligible for recognition. The set of words currently eligible for recognition and the set of words capable of recognition may or may not be the same. These grammars (136), lexicons, and acoustic models may be stored locally, but are components that may be downloaded from a library or repository on demand through a network.

Also stored in RAM (168) is an operating system (154). Operating systems useful in voice servers according to embodiments of the present invention include UNIX™, Linux™, Microsoft Windows 7™, IBM's AIX™, IBM's i5/OS™, Google™ Android™, and others as will occur to those of skill in the art. Operating system (154), speech engine (153), grammars (136), audio analysis rules (130), image analysis rules (132), object image definitions (138), and the data processing module (106) in the example of FIG. 2 are shown in RAM (168), but many components of such software typically are stored in other secondary storage or other non-volatile memory storage, for example, on a flash drive, optical drive, disk drive, or the like.

The data processing system (104) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in a data processing system according to embodiments of the present invention include the Intel Northbridge, the Intel Memory Controller Hub, the Intel Southbridge, and the Intel I/O Controller Hub. Examples of expansion buses useful in data processing systems according to embodiments of the present invention include Peripheral Component Interconnect (‘PCI’) and PCI-Extended (‘PCI-X’) bus, as well as PCI Express (‘PCIe’) point to point expansion architectures and others.

The data processing system (104) of FIG. 2 includes storage adapter (172) coupled through expansion bus (160) and bus adapter (158) to processor (156) and other components of the data processing system (104). Storage adapter (172) connects non-volatile memory (170) to the data processing system (104). Storage adapters useful in data processing systems according to embodiments of the present invention include Integrated Drive Electronics (‘IDE’) adapters, Small Computer System Interface (‘SCSI’) adapters, Universal Serial Bus (‘USB’) and others as will occur to those of skill in the art. In addition, non-volatile computer memory may be implemented for an data processing system as an optical disk drive, electrically erasable programmable read-only memory (so-called ‘EEPROM’ or ‘Flash’ memory), RAM drives, and so on, as will occur to those of skill in the art.

The example data processing system (104) of FIG. 2 includes one or more input/output (‘I/O’) adapters (178). I/O adapters in data processing systems implement user-oriented input/output through, for example, software drivers and computer hardware for controlling output to display devices such as computer display device (180), as well as user input from user input devices (181) such as keyboards and mice. The example data processing system of FIG. 2 also includes a video adapter (209), which is an example of an I/O adapter specially designed for graphic input to the data processing system (104) from cameras (200). Video adapter (209) is connected to processor (156) through a high speed video bus (164), bus adapter (158), and the front side bus (162), which is also a high speed bus.

The exemplary data processing system (104) of FIG. 2 includes a communications adapter (167) for data communications with other computer (182) and for data communications with a data communications network (100) through a transceiver (204). Such data communications may be carried out serially through RS-232 connections with other computers, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for testing a grammar used in speech recognition for reliability in a plurality of operating environments having different background noise according to embodiments of the present invention include modems for wired dial-up communications, Ethernet (IEEE 802.3) adapters for wired data communications network communications, and 802.11 adapters for wireless data communications network communications. The transceiver (204) may be implemented using use a variety of technologies, alone or in combination, to establish wireless communication with network (100) including, for example, Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), Integrated Digital Enhanced Network (iDEN), IEEE 802.11 technology, Bluetooth, WiGig, WiMax, Iridium satellite communications technology, Globalstar satellite communications technology, or any other wireless communications technology as will occur to those of skill in the art.

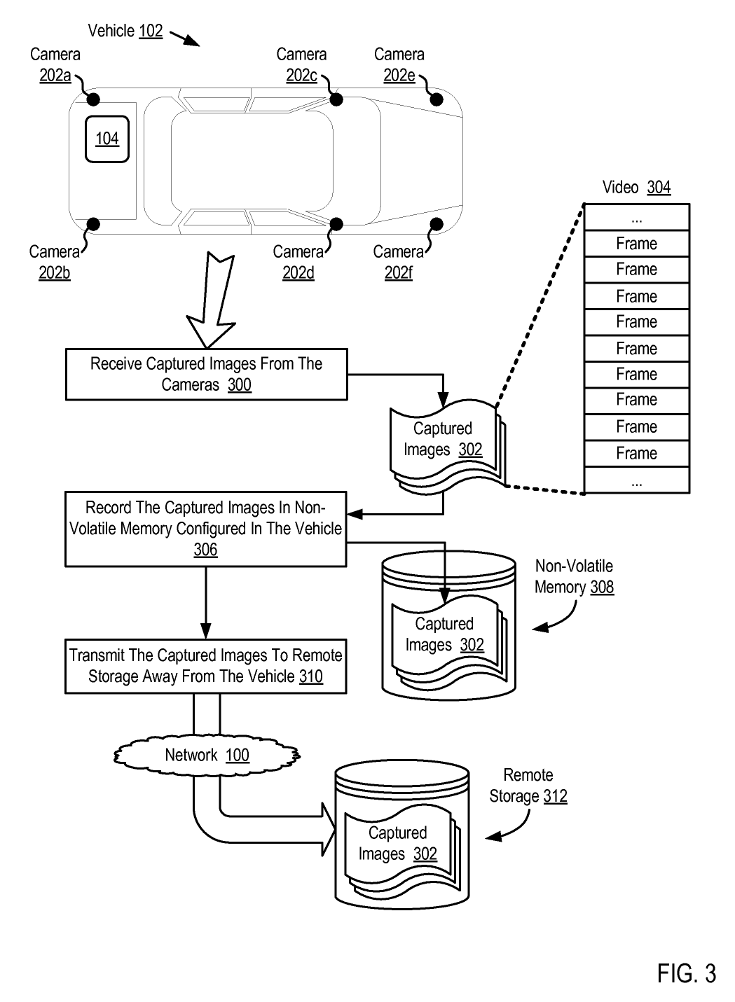

For further explanation, FIG. 3 sets forth a flow chart illustrating an exemplary vehicle monitoring system for use with a vehicle (102) according to embodiments of the present invention. In the example of FIG. 3, the vehicle (102) has cargo and non-cargo regions. The non-cargo regions include an engine compartment and an undercarriage. Cameras (202) of FIG. 3 are configured in the non-cargo regions of the vehicle (102) to capture images of the non-cargo regions. In this manner, images of anyone servicing these areas of the vehicle as well as their activities will servicing the vehicle will also be captured by camera (202).

In FIG. 3, readers will note that cameras (202c-f) are installed in the engine compartment of vehicle (102), and cameras (202a-b) are installed along the undercarriage of the vehicle (102) near the rear wheel wells. The placement of these cameras (202), however, are for explanation only, not for limitation. Cameras may be installed in any portion of the non-cargo regions of a vehicle in which a user may have an interest.

The vehicle monitoring system of FIG. 3 includes a data processing system (104) mounted to the vehicle (102). The data processing system (104) of FIG. 3 is operatively connected to the cameras (202). The data processing system (104) of FIG. 3 comprises at least one processor, at least one memory, and at least one transmitter operatively connected together.

In the example of FIG. 3, the data processing system (104) receives (300) captured images (302) from the cameras (202). The data processing system (104) may receive (300) the captured images (302) from the cameras (202) according to FIG. 3 by sending a control signal to the cameras (202) that instructs the cameras (202) to start transmitting images captured by the cameras (202) and buffering the captured images (302) from each camera (202) in a separate memory buffer, while awaiting further processing.

The captured images (302) in FIG. 3 are implemented as video (304). A video is a collection of frames typically used to create the illusion of a moving picture. Each frame of the digital video is image data for rendering one still image and metadata associated with the image data, and in some case also the audio associated with that frame. The metadata of each frame may include synchronization data for synchronizing the frame with an audio stream, configurational data for devices displaying the frame, digital video text data for displaying textual representations of the audio associated with the frame, and so on. Displaying a frame refers to rendering image data of the frame on the display screen along with any metadata of the frame encoded for display such as, for example, closed captioning text. A display screen may display the video (304) by flashing each frame on a display screen for a brief period of time, typically 1/24th, 1/25th or 1/30th of a second, and then immediately replacing the frame displayed on the display screen with the next frame. As a person views the display screen, persistence of vision in the human eye blends the displayed frames together to produce the illusion of a moving image.

In the example of FIG. 3, the data processing system (104) then records (306) the captured images (302) in non-volatile memory (308) configured in the vehicle (102). The data processing system (104) may record (306) the captured images (302) in non-volatile memory (308) configured in the vehicle (102) according to FIG. 3 by invoking a write procedure of a storage device driver and passing the write procedure the memory address of the buffer containing capture images (302).

In the example of FIG. 3, the data processing system (104) then transmits (310) the captured images (302) to remote storage (312) away from the vehicle (102). The data processing system (104) may transmit (310) the captured images (302) to remote storage (312) away from the vehicle (102) according to the example of FIG. 3 by invoking a send procedure of a network device driver and passing the send procedure the memory address of the buffer containing capture images (302). The network device adapter may then open a data communications channel through the network (100) with a remote storage device (312) and transmit the capture images (302) to the remote storage device (312).

As previously mentioned, cameras installed in the vehicle (102) of FIG. 3 may include their own non-volatile memory storage, which may make having the data processing system (104) record the captured images unnecessarily redundant. Accordingly, the data processing system (104) of FIG. 3 may leave out or skip over the process of recording the captured images in non-volatile memory (308) configured in the vehicle (102). In this manner, the data processing system (104) of FIG. 3 may merely receive (300) captured images from the cameras (202) and transmit (310) the captured images (302) to remote storage (312) away from the vehicle (102).

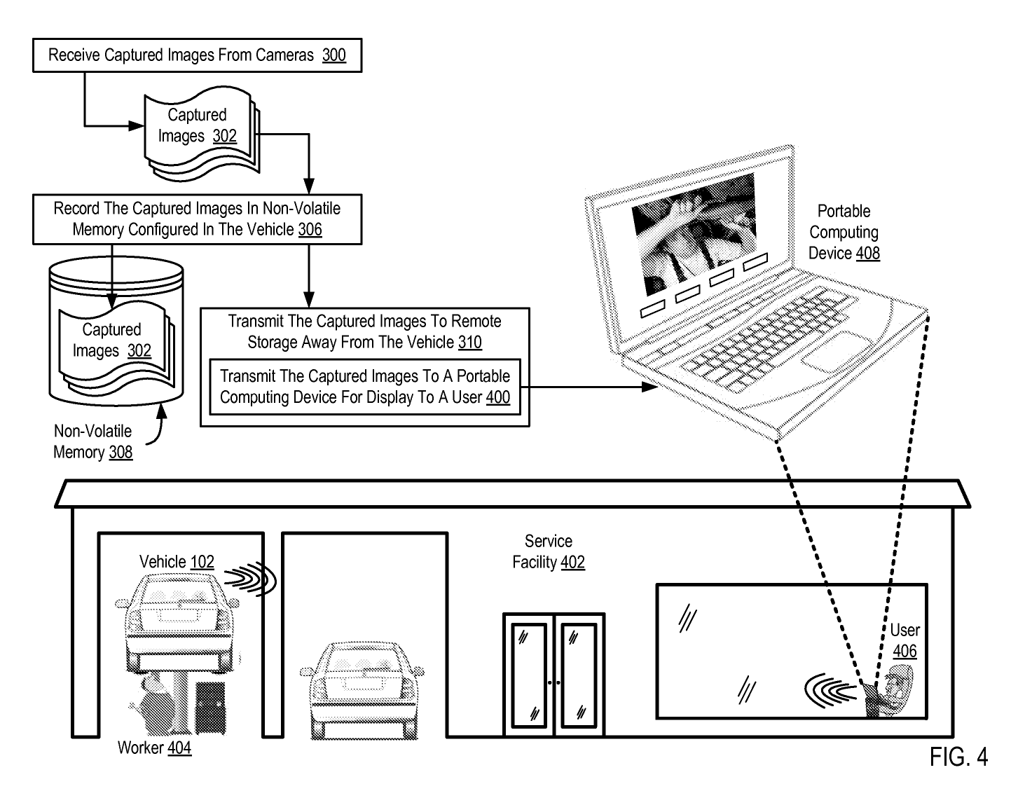

Transmitting the capture images (302) to the remote storage (312) according the example of FIG. 3 advantageously prevents an unsavory service repair person from eliminating evidence of malfeasance by tampering with or destroying the data processing system (102). Vehicle monitoring systems according to embodiments of the present invention may also benefit users in other ways. For example, when the remote storage device receiving the capture images is a handheld device, a user of the handheld device could watch the service repair person work on the vehicle. For further explanation, FIG. 4 sets forth a flow chart illustrating an exemplary vehicle monitoring system for use with a vehicle (102) according to embodiments of the present invention. In FIG. 4, the vehicle (102) is being serviced at a service facility (402) by a service worker (404). While the vehicle (102) is being serviced, the user (406) waits in the service facility's waiting area and operates the user's portable computing device (408).

The vehicle monitoring system of FIG. 4 is similar to the vehicle monitoring system of FIG. 3. In the example of FIG. 4, the data processing system receives (300) captured images (302) from the cameras (202), records (306) the captured images (302) in non-volatile memory (308) configured in the vehicle (102), and transmits (310) the captured images (302) to remote storage (312) away from the vehicle (102).

In the example of FIG. 4, however, transmitting (310) the captured images (302) to remote storage (312) away from the vehicle (102) includes establishing a data communications channel with a portable computing device (408) and transmitting (400) the captured images (302) to the portable computing device (408) for display to the user (406). The data processing system in the example of FIG. 4 may establish a data communications channel with a portable computing device (408) using Bluetooth technology, IEEE 802.11 technology, or other small-range networking arrangement when the distance between the vehicle and the waiting areas of the service facility (402) is not too great. For a more universal range solution, the data processing system and the portable computing device may connect through the cellular data network, satellite data network, or other longer-range networking solution.

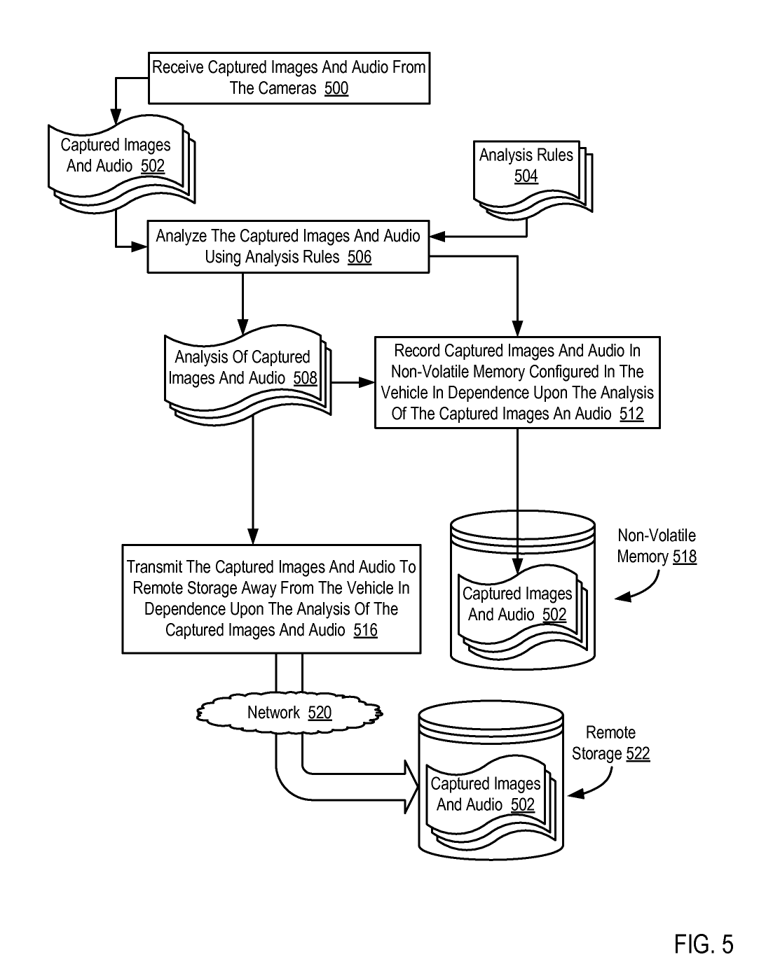

For further explanation, FIG. 5 sets forth a flow chart illustrating an exemplary vehicle monitoring system for use with a vehicle (102) according to embodiments of the present invention. The vehicle monitoring system of FIG. 5 is similar to the vehicle monitoring system in the example of FIG. 3. The vehicle (102) of FIG. 5 has cargo and non-cargo regions. The non-cargo regions include an engine compartment and an undercarriage. In FIG. 5, the cameras are configured in the non-cargo regions of the vehicle (102) to capture images and audio from the non-cargo regions. In this manner, images and sounds of anyone servicing these areas of the vehicle as well as their activities will be servicing the vehicle will also be captured by camera. Although the cameras described with reference to the example of FIG. 5 have microphones for capturing audio, readers will note that in some embodiments, the cameras may only capture silent images or video footage, while audio is captured through separate microphones installed in the non-cargo reaches. In fact, in some embodiments the microphone may be installed in locations best suited for picking up conversations occurring near the non-cargo regions, while the cameras are installed in locations suitable for capturing the best images.

In the example of FIG. 5, the vehicle monitoring system operates to receive (500) captured images and audio (502) from the cameras. The vehicle monitoring system operates to receive (500) captured images and audio (502) from the cameras according to the embodiment described with reference to FIG. 5 by sending a control signal to the cameras that instructs the cameras to start transmitting images and audio captured by the cameras and buffering the captured images and audio from each camera in a separate memory buffer, while awaiting further processing.

The vehicle monitoring system described with reference to FIG. 5 then analyzes (506) the captured images and audio (502) using analysis rules (504). The analysis rules (504) of FIG. 5 specify criteria against which certain characteristics of the captured images and audio (502) are compared to identify a resultant course of action to be taken. Analyzing (506) the captured images and audio (502) using analysis rules (504) in accordance with the example of FIG. 5 produces an analysis (508) of the captured images and audio. The analysis (508) of FIG. 5 may be implemented as a numeric value that corresponds with the futures action to be taken by the vehicle monitoring system, pointer to a program function or procedure call of a software module, a bit value for a memory register, a variable value for a memory location, or any other identifier specifying the future actions to be taken by the vehicle monitoring system of FIG. 5.

In the example of FIG. 5, the vehicle monitoring system records (512) the captured images and audio (510) in non-volatile memory configured in the vehicle in dependence upon the analysis (508) of the captured images and audio. The vehicle monitoring system may record (512) in such a manner according to the example described with reference to FIG. 5 by determining whether the analysis (508) of the captured images and audio specifies that it is time to begin recording the captured images and audio (502), and if so, then passing the memory location of the buffers containing the captured images and audio (502) to a storage device driver that the loads those captured images and audio (502) into the non-volatile memory (518).

In the example of FIG. 5, the vehicle monitoring system transmits (516) the captured images and audio (502) to remote storage (522) in dependence upon the analysis (508) of the captured images and audio. The vehicle monitoring system may transmit (516) in such a manner according to the example described with reference to FIG. 5 by determining whether the analysis (508) of the captured images and audio specifies that it is time to begin transmitting the captured images and audio (502), and if so, then passing the memory location of the buffers containing the captured images and audio (502) to a network device driver that packetizes the captured images and audio (502) and sends these packets across network (520) to a device hosting remote storage (522), which in turn loads the those captured images and audio (502) into memory.

Readers will understand that while the embodiment described with reference to FIG. 5 references the processing of both images and audio, either images or audio alone could be processed in a similar manner.

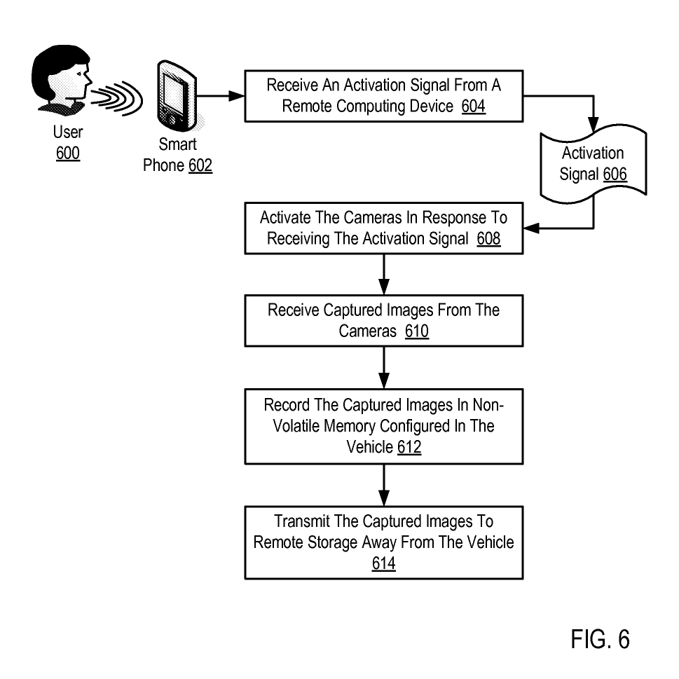

While certain processing functions of the vehicle monitoring system described with reference to FIG. 5 are activated depending on the vehicle monitoring system's analysis of captured images or audio, the vehicle monitoring system described with reference to FIG. 6 is activated based on a user's selection. For further explanation, FIG. 6 sets forth a flow chart illustrating another exemplary vehicle monitoring system for use with a vehicle according to embodiments of the present invention.

In the example of FIG. 6, a user (600) operates a smart phone (602). The smart phone (602) has an operating system installed upon it and a vehicle monitoring system application that communicates via a network with a vehicle monitoring system according to embodiments of the present invention. Such communication may be encrypted or otherwise secured as will occur to those of skill in the art. The vehicle monitoring system of FIG. 6 is similar to the vehicle monitoring systems described with reference to the other Figures. The vehicle of FIG. 6 has cargo and non-cargo regions. The non-cargo regions include an engine compartment and an undercarriage. In FIG. 6, the cameras are configured in the non-cargo regions of the vehicle to capture images from the non-cargo regions.

In the example of FIG. 6, the vehicle monitoring system receives (604) an activation signal (606) form a remote computing device. The remote computing device in the example of FIG. 6 is the smart phone (602), but readers will note that the remote computing device may be any computing device connected to the vehicle monitoring system through a network connection. The activation signal (606) of FIG. 6 is an indicator that communicates a user's desire to activate the vehicle monitoring system. The vehicle monitoring system may receive (604) an activation signal (606) form a remote computing device according to the example of FIG. 6 by receiving data packets comprising the activation signal (606) through the system's network adapter, which in turn stores the data packets in a receiving buffer for the network adapter, then reading the data packets from the receive buffer, reconstituting the activation signal (606) from the data packets, and storing the activation signal (606) in a particular memory location accessible to some of the other components of the vehicle monitoring system.

In the example of FIG. 6, the vehicle monitoring system then activates (608) the cameras in response to receiving the activation signal (606). The vehicle monitoring system may activate (608) the cameras in response to receiving the activation signal (606) by determining whether the activation signal (606) has been stored in the particular memory location, and if not, checking again after a predetermined timeout period, and if so, activating the cameras.

The remaining actions performed by the exemplary vehicle monitoring system described with reference to FIG. 6 operates in a manner similar to the vehicle monitoring system described with reference to FIG. 3. The exemplary vehicle monitoring system described with reference to FIG. 6 receives (610) captured images from the cameras, records (612) the captured images in non-volatile memory configured in the vehicle, and transmits (614) the captured images to remote storage away from the vehicle.

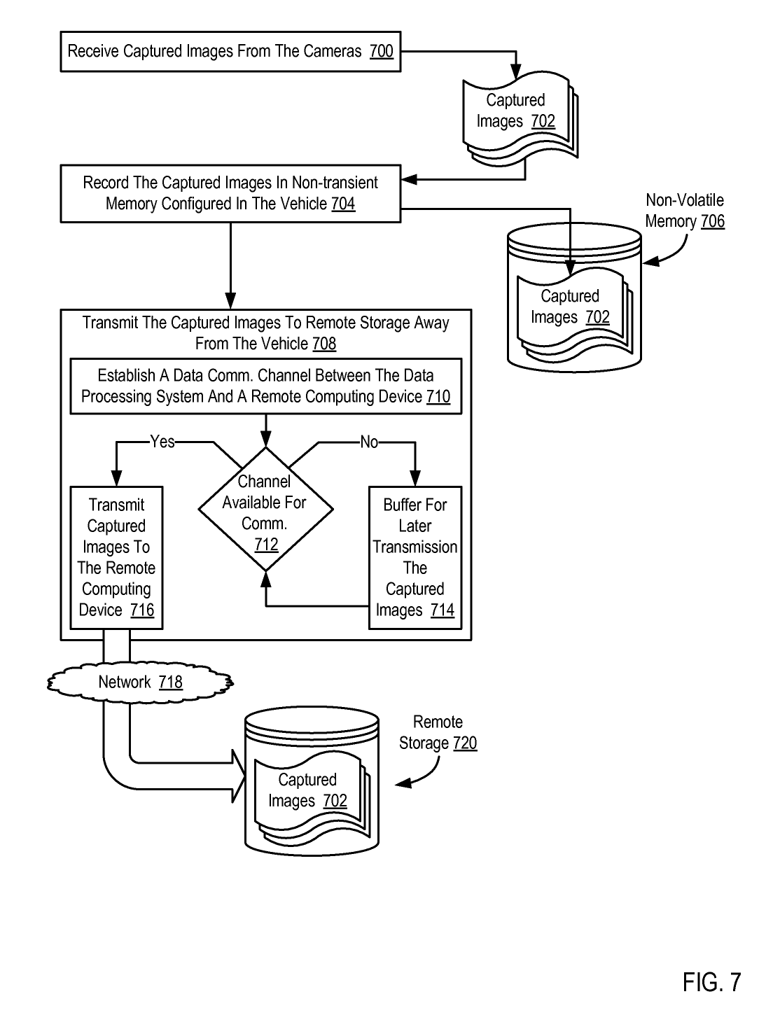

Under some conditions, the data communications connection between the vehicle monitoring system according to embodiments of the present invention and the remote storage device may not be continuous. Certain embodiments of the vehicle monitoring systems may be specially adapted for circumstance when data communications is intermittent. Turning to FIG. 7, FIG. 7 sets forth a flow chart illustrating operation of an exemplary vehicle monitoring system for use with a vehicle according to embodiments of the present invention.

The vehicle monitoring system of FIG. 7 is similar to the vehicle monitoring system in the example of the previous Figures. The vehicle of FIG. 7 has cargo and non-cargo regions. The non-cargo regions include an engine compartment and an undercarriage. In FIG. 7, cameras are configured in the non-cargo regions of the vehicle to capture images from the non-cargo regions. The exemplary vehicle monitoring system described with reference to FIG. 7 receives (700) captured images (702) from the cameras, records (704) the captured images (702) in non-volatile memory (706) configured in the vehicle, and transmits (708) through the network (718) the captured images (702) to remote storage (720) away from the vehicle.

In the example of FIG. 7, however, transmitting (708) the captured images (702) to remote storage (720) includes: attempting (710) to establish a data communications channel between the vehicle monitoring system and a remote computing device hosting the remote storage (720); determining (712) whether the data communications channel is available for communications; if not, buffering (714) for later transmission the captured images (702); if so, transmitting (716) captured images to the remote computing device.

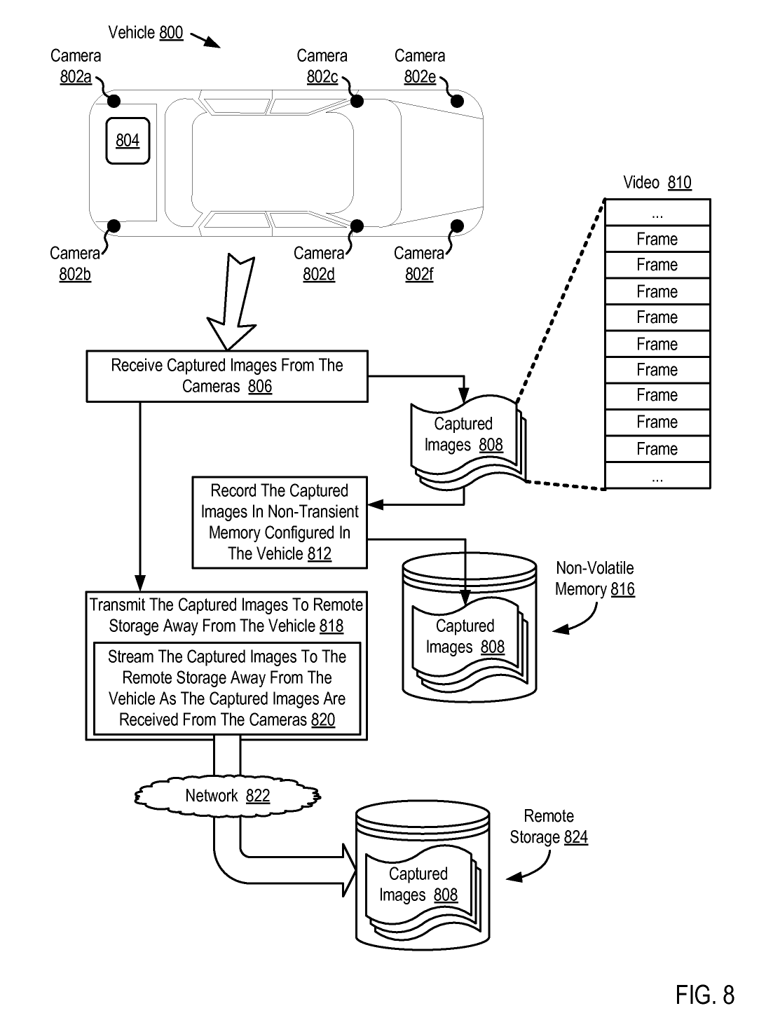

When data communications between the vehicle monitoring system and remote storage are available, the vehicle monitoring system may transmit data to remote storage by streaming the data in near or actual real-time or transmitting the data to the remote storage later from local storage in the non-volatile memory of the vehicle, or some combination thereof. Turning now to FIG. 8, FIG. 8 sets forth a flow chart illustrating operation of an exemplary vehicle monitoring system for use with a vehicle according to embodiments of the present invention.

The vehicle monitoring system of FIG. 8 is similar to the vehicle monitoring system in the example of the previous Figures. The vehicle (800) of FIG. 8 has cargo and non-cargo regions. The non-cargo regions include an engine compartment and an undercarriage. In FIG. 8, cameras (802) are configured in the non-cargo regions of the vehicle to capture images (808) from the non-cargo regions. These images (808) of FIG. 8 are implemented as a video (810) composed of multiple frames. The exemplary vehicle monitoring system described with reference to FIG. 8 receives (806) captured images (808) from the cameras (802), records (812) the captured images (808) in non-volatile memory (816) configured in the vehicle (800), and transmits (818) through the network (822) the captured images (808) to remote storage (824) away from the vehicle (800).

In the example of FIG. 8, however, transmitting (818) the captured images (808) to remote storage (824) includes streaming (820) the captured images to the remote storage (824) away from the vehicle (800) as the captured images are received from the cameras (800). The vehicle monitoring system may stream (820) the captured images to the remote storage according to the embodiment described with reference to FIG. 8 by passing to a network device driver the address and characteristics of the memory buffer used to store the images (808) as those images (808) are received in the data processing system (804) from the cameras. In this manner, the network device driver may pull images (808) from the buffer as those images are placed in the buffer when received from the cameras.

Readers will note that the streaming (820) of the captured images (806) according to the embodiments described with reference to FIG. 8 may occur concurrently with the recording of the captured images to non-volatile memory (816) of the vehicle (800). In other embodiments, however, the streaming (820) of the captured images (806) according to the embodiments described with reference to FIG. 8 may occur prior to the recording of the captured images (806) to non-volatile memory (816) of the vehicle (800).

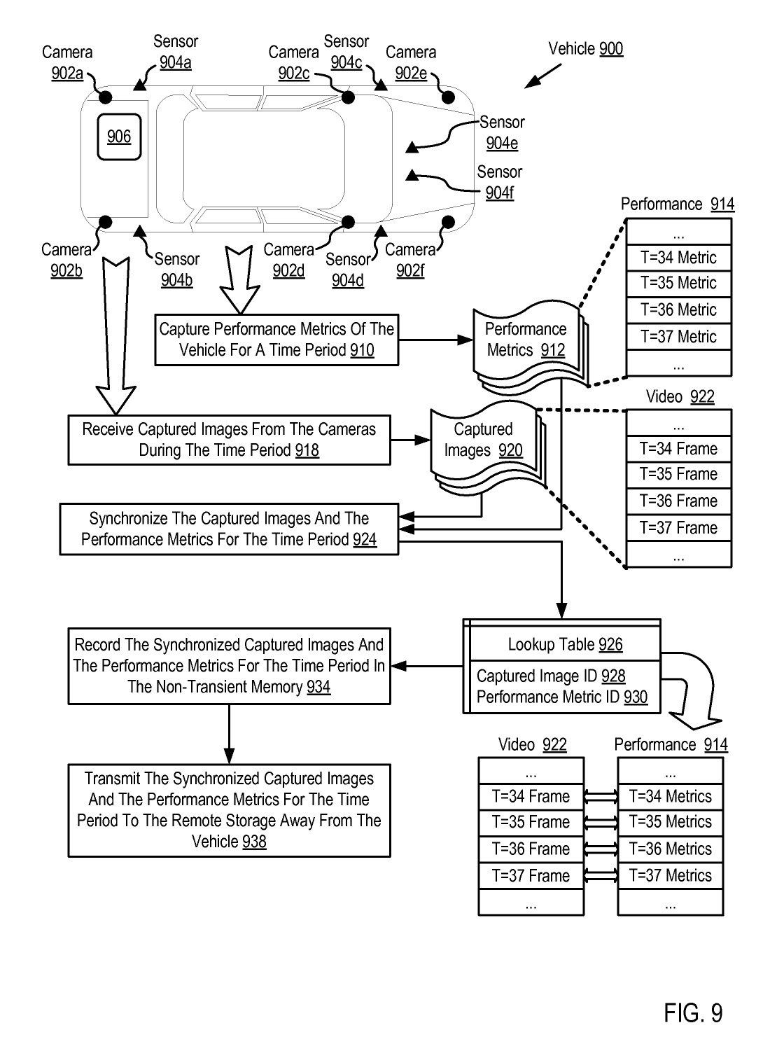

In addition to capturing images or audio, some vehicle monitoring systems according to embodiments of the present invention may also capture performance metrics of the vehicle. For further explanation, FIG. 9 sets forth a flow chart illustrating operation of an exemplary vehicle monitoring system for use with a vehicle according to embodiments of the present invention that capture performance metrics. The exemplary vehicle monitoring system described with reference to FIG. 9 is similar to previously described vehicle monitoring systems described with reference to other Figures. The vehicle (900) of FIG. 9 has cargo and non-cargo regions. The non-cargo regions include an engine compartment and an undercarriage. Cameras (902) of FIG. 9 are configured in the non-cargo regions of the vehicle (900) to capture images of the non-cargo regions. In this manner, images of anyone servicing these areas of the vehicle as well as their activities will servicing the vehicle will also be captured by camera (902).

In the example of FIG. 9, performance sensors (904a-f) are installed to measure performance of the vehicle (900) at various locations. Readers will note, however, that the placement of the sensors (904) at the locations depicted in FIG. 9, however, are for example only, not for limitation. Each sensor (904) of FIG. 9 is a device that measures a physical quantity and converts it to a signal which can be manipulated by a data processing system. These signals captured by sensors are generally referred to as performance metrics. The exemplary sensors (900) of FIG. 9 may be used to measure a variety of aspects of the vehicle (102) in FIG. 9 including temperature, torque, rotations per minute, pressure, voltage, current, and the like.

The vehicle monitoring system of FIG. 9 includes a data processing system (906) mounted to the vehicle (900). The data processing system (906) of FIG. 9 is operatively connected to the cameras (902) and the performance sensors (904). The data processing system (906) of FIG. 9 comprises at least one processor, at least one memory, and at least one transmitter operatively connected together.

In the example of FIG. 9, the vehicle monitoring system captures (910) performance metrics (912) of the vehicle (900) for a time period. Capturing (910) the performance metrics (912) of the vehicle (900) for a time period according to the example described with reference to FIG. 9 may be carried out by sending a control signal to the sensors (904) that instructs the sensors (904) to start transmitting performance metrics (912) and buffering the performance metrics (912) from each sensor (904) in a separate memory buffer, while awaiting further processing. To keep track of the time when the performance metrics (912) was measured, the sensors (904) may include a clock that embeds or stamps each measurement with a timestamp that can be later used in the synchronization process described further below. Alternatively, the data processing system of the vehicle monitoring system may store each performance metric (912) with a timestamp when the performance metrics (912) are stored in buffers. Of course other methods of associating a particular performance metric with a time period as will occur to those of skill in the art may also be useful. In the example of FIG. 9, the performance table (914) shows each performance metric with a timestamp that identifies the point in time or the time period associated with each metric.

In the example of FIG. 9, the vehicle monitoring system receives (918) captured images (920) from the cameras (902) during the same time period over which the performance metrics (912) are captured. Receiving (918) captured images (920) from the cameras (902) during the same time period according to the example described with reference to FIG. 9 may be carried out by sending a control signal to the cameras (902) that instructs the cameras (902) to start transmitting images captured by the cameras (902) and buffering the captured images (920) from each camera (902) in a separate memory buffer, while awaiting further processing. To keep track of the time when the images (920) were captured, the cameras (902) may timestamp each of the images (92) that can be later used in the synchronization process described further below. Alternatively, the data processing system of the vehicle monitoring system may store each performance metric (912) with a timestamp when the performance metrics (912) are stored in buffers. Of course other methods of associating a particular performance metric with a time period as will occur to those of skill in the art may also be useful. In the example of FIG. 9, the captured images (920 are implemented as video (922) composed of various frames, each frame being associated with a particular point in time or time period over which the frame was captured by the cameras (902).

The vehicle monitoring system described with reference to FIG. 9 synchronizes (924) the captured images (920) and the performance metrics (912) for the time period. Synchronizing (924) the captured images (920) and the performance metrics (912) according to embodiments described with reference to FIG. 9 may be carried out by associating the performance metrics (912) and captures images (920) having the same timestamp in a lookup table (926). Each row of the lookup table (926) in the example of FIG. 9 identifies a captured image and performance metric that was captured at the same time or over a similar time period. Each row of the table (926) in FIG. 9 includes a captured image identifier (928) and a performance metric identifier (930). In this way, for example, the identifier for the frame with timestamp T=34 is associated with the identifier for the performance metrics with timestamp T=34. Similarly, the identifier for the frame with timestamp T=35 is associated with the identifier for the performance metrics with timestamp T=35, the identifier for the frame with timestamp T=36 is associated with the identifier for the performance metrics with timestamp T=36, and the identifier for the frame with timestamp T=37 is associated with the identifier for the performance metrics with timestamp T=37.

In the example of FIG. 9, the vehicle monitoring system records (934) the synchronized captured images and the performance metrics for the time period in the non-volatile memory. Recording (934) the synchronized captured images and the performance metrics according to the example described with reference to FIG. 9 may be carried out in a variety of ways. The vehicle monitoring system may pass the memory address of the buffers holding the captured images (920) and the performance metrics (912) and the lookup table (926) to a storage device driver that in turn writes the data to the non-volatile storage. Alternatively, the vehicle monitoring system may store the performance metric data directly into non-visible regions of the corresponding frame in the capture images and store those frames with the performance data embedded therein in non-volatile storage.

In the example of FIG. 9, the vehicle monitoring system transmits (938) the synchronized captured images and the performance metrics for the time period to the remote storage away from the vehicle (900). Transmitting (938) the synchronized captured images and the performance metrics according to the example described with reference to FIG. 9 may be carried out by pass the memory address of the buffers holding the captured images (920) and the performance metrics (912) and the lookup table (926) to a network device driver that in turn packetizes the data and transmits the data packets to a remote computing device for storage.

Synchronizing the captured images and performance metrics as described with reference to FIG. 9 advantageously allows a user to later view a captured image and performance characteristics of the vehicle at the time the image was captured. For example, if a user views images of a mechanic draining oil from the oil pan, the user may also be able to determine if the engine was running at the time the oil was drained. In such a manner, having the captured images and performance data synchronized may allow a user to determine or verify causes of vehicle damages.

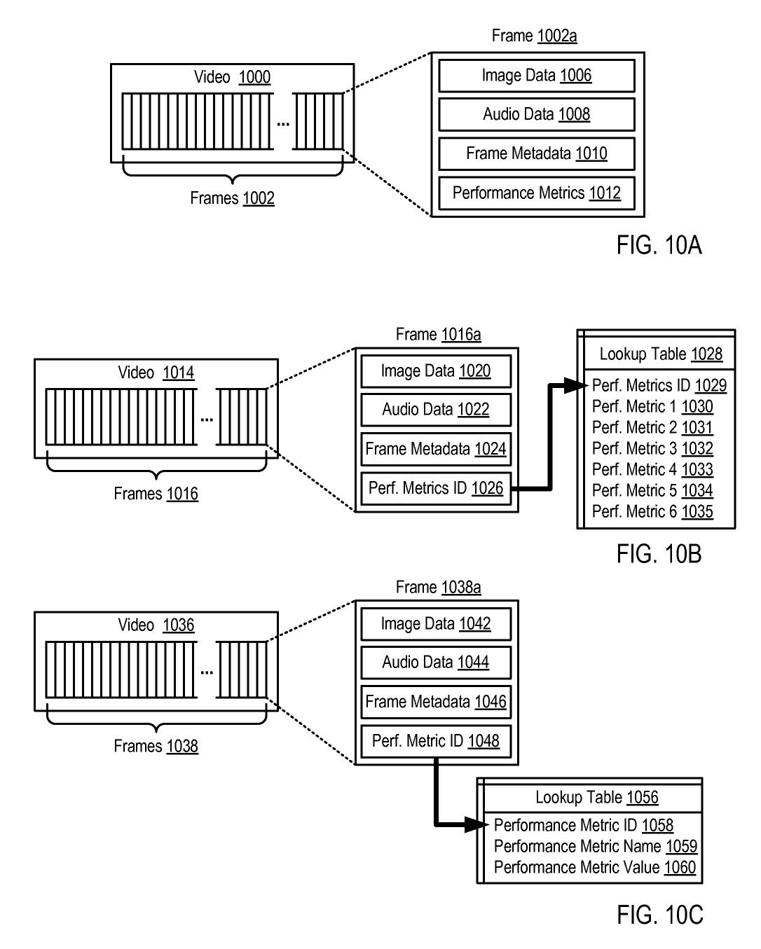

There are a variety of ways that the captured image data and performance metrics could be synchronized. FIGS. 10A-C provide examples of three different ways such synchronization could be maintained, but readers will note that other methods of synchronization as will occur to those of skill in the art may also be used. Turning now to FIGS. 10A-C, FIGS. 10A-C set forth exemplary videos comprising exemplary image data for use with an exemplary vehicle monitoring system according to embodiments of the present invention.

In FIG. 10A, exemplary captured images for use with vehicle monitoring systems according to embodiments of the present invention are implemented as a video (1000) with frames (1002). In FIG. 10A, the performance metrics captured for a particular time period are embedded in the video frames captured during that same time period. Accordingly, the frame (1002a) of FIG. 10A includes image data (1006), audio data (1008), frame metadata (1010) and performance metrics (1012). In this manner, rendering the frame for display to a user also allows a system to render the performance metrics that were measured at the same time the image was captured. The performance metrics (1012) may be rendered as part of the image data (1006) or rendered as a overlay to the image data (1006).

In FIG. 10B, exemplary captured images for use with vehicle monitoring systems according to embodiments of the present invention are implemented as a video (1014) with frames (1016). In FIG. 10B, an identifier for a set of performance metrics captured for a certain time period is embedded in a video frame captured during that same time period. Accordingly, the frame (1016a) of FIG. 10B includes image data (1020), audio data (1022), frame metadata (1024) and a performance metrics identifier (1026). The performance metrics identifier (1026) of FIG. 10B identifies a sets of performance metrics (1030-1035) stored together in a lookup table (1028). Each row of the table (1028) of FIG. 10B associates a performance metric identifier (1029) with a set of performance metrics (1030-1035). In this manner, when a system renders a frame for display to a user, the system can then lookup the set of performance metrics corresponding with that frame and render one or more of the performance metrics from the set. As mentioned previously, the performance metrics (1030-1035) may be rendered as part of the image data (1020) or rendered as an overlay to the image data (1020).

In FIG. 10C, exemplary captured images for use with vehicle monitoring systems according to embodiments of the present invention are implemented as a video (1036) with frames (1038). The example of FIG. 10B may be limited in the number of performance metrics that can be associated with a frame to the number of performance metrics specified in each row of lookup table (1028) in FIG. 10B. In FIG. 10C, an identifier associated with any number of performance metrics captured for a certain time period is embedded in a video frame captured during that same time period. Accordingly, the frame (1038a) of FIG. 10C includes image data (1042), audio data (1044), frame metadata (1046) and a performance metric identifier (1048). The performance metric identifier (1048) of FIG. 10C identifies one or more performance metrics stored together in a lookup table (1056). Each row of the table (1056) of FIG. 10C associates a performance metric identifier (1058) with one or more performance metrics, which in this example for explanation only, not limitation, is specified using a metric name (1059) and metric value (1060). In this manner, when a system renders a frame for display to a user, the system can then lookup one or more performance metrics corresponding with that frame and render any number of those performance metrics on a screen for a user with or without the corresponding image.

Readers will recall from the exemplary vehicle monitoring systems described with reference to FIG. 7 and FIG. 8 that captured images may be transmitted intermittently from the vehicle monitoring system to remote storage and that the capture images may be streamed to the remote storage both concurrently with and prior to storing the captured images locally in the non-volatile memory storage. Those of skill in the art will recognized that these same processes may be applied with synchronized images and performance metrics.

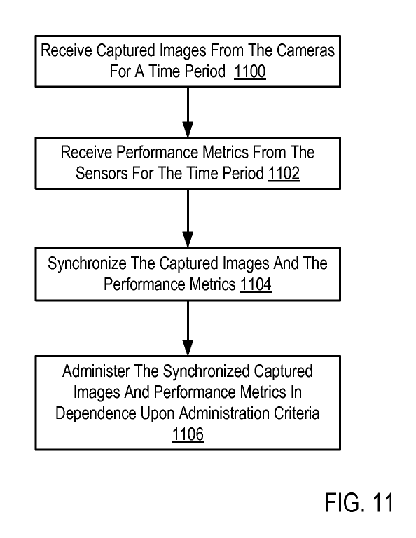

While FIG. 10 a vehicle monitoring system that both records the synchronized captured images and the performance metrics in the non-volatile memory and transmits the synchronized captured images and the performance metrics for the time period to the remote storage away from the vehicle, other embodiments may not perform both these steps. For further explanation, FIG. 11 sets forth a flow chart illustrating operation of an exemplary vehicle monitoring system for use with a vehicle according to embodiments of the present invention.

The example described with reference to FIG. 11 is similar to the example described with reference to FIG. 10. The vehicle has cargo and non-cargo regions. The non-cargo regions include an engine compartment and an undercarriage. One or more cameras are configured in the non-cargo regions to capture images of the non-cargo regions. One or more sensors are configured in the vehicle for capturing performance metrics of the vehicle. A data processing system mounted to the vehicle. The data processing system is operatively connected to the cameras and the sensors.

The exemplary vehicle monitoring system described with reference to FIG. 11 also operates similar to the vehicle monitoring system described with reference to FIG. 10. The vehicle monitoring system described with reference to FIG. 11 receives (1100) captured images from the cameras for a time period, receives (1102) performance metrics from the sensors for the time period, and synchronizes (1104) the captured images and the performance metrics.

The vehicle monitoring system described with reference to FIG. 11 then administers (1106) the synchronized captured images and performance metrics in dependence upon administration criteria. The administration criteria described with reference to FIG. 11 specifies the manner in which the data processing system of the vehicle monitoring system of FIG. 11 is to process the synchronized captured images and performance metrics. The administration criteria described with reference to FIG. 11 may specified by a user's selection through a remote computing device that is then communicated to the vehicle monitoring system through a network, may be previously specified by a set of rules that instruct the vehicle monitoring system how to process the synchronized data based on the presence or absence of certain condition or other criteria.

Under some circumstances, the vehicle monitoring system described with reference to FIG. 11 may administer (1106) the synchronized captured images and performance metrics by transmitting the synchronized captured images and performance metrics to remote storage away from the vehicle without storing the synchronized captured images and performance metrics in local permanent storage. Under other conditions, the vehicle monitoring system described with reference to FIG. 11 may administer (1106) the synchronized captured images and performance metrics by recording the synchronized captured images and performance metrics in non-volatile memory configured in the vehicle, without transmitting the synchronized data to remote storage. In still other circumstance, however, the vehicle monitoring system described with reference to FIG. 11 may administer (1106) the synchronized captured images and performance metrics by both recording the synchronized captured images and performance metrics in non-volatile memory configured in the vehicle and transmitting the synchronized captured images and performance metrics to remote storage away from the vehicle.

Exemplary embodiments of the present invention are described largely in the context of a fully functional vehicle monitoring systems for use with a vehicle. Readers of skill in the art will recognize, however, that portions of the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, flash storage, magnetoresistive storage, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A vehicle monitoring system for use with a vehicle, the vehicle having cargo and non-cargo regions, the non-cargo regions comprising an engine compartment and an undercarriage, the vehicle monitoring system comprising:
one or more cameras configured in the non-cargo regions to capture images of the non-cargo regions;
a data processing system mounted to the vehicle, the data processing system operatively connected to the cameras, the data processing system comprising at least one processor, at least one memory, and at least one transmitter operatively connected together for:
receiving captured images from the cameras;
recording the captured images in non-volatile memory configured in the vehicle;
transmitting the captured images to remote storage away from the vehicle.

2. The vehicle monitoring system of claim 1 wherein the transmitting the captured images to remote storage away from the vehicle further comprises:
attempting to establish a data communications channel between the data processing system and a remote computing device, the remote computing device comprising the remote storage;
determining whether the data communications channel is available for communications;
if the data communications channel is available for communications, transmitting the captured images to the remote computing device for storage in the remote storage;
if the data communications channel is not available for communications, buffering for later transmission the captured images until the data communications channel is available for communications.

3. The vehicle monitoring system of claim 1 wherein transmitting the captured images to remote storage away from the vehicle further comprises streaming the captured images to the remote storage away from the vehicle as the captured images are received from the cameras.

4. The vehicle monitoring system of claim 1 wherein transmitting the captured images to remote storage away from the vehicle further comprises transmitting the captured images to remote storage away from the vehicle concurrently with the recording of the captured images in the non-volatile memory.

5. The vehicle monitoring system of claim 1 wherein:
the vehicle further comprises one or more sensors configured in the vehicle for capturing performance metrics of the vehicle for a time period;
receiving captured images from the cameras further comprises receiving captured images from the cameras during the time period;
the at least one processor, the at least one memory, and the at least one transmitter of the data processing system are operatively connected together for capturing the performance metrics of the vehicle for the time period and synchronizing the captured images and the performance metrics for the time period;
recording the captured images in non-volatile memory configured in the vehicle further comprises recording the synchronized captured images and the performance metrics for the time period in the non-volatile memory; and
transmitting the captured images to remote storage away from the vehicle further comprises transmitting the synchronized captured images and the performance metrics for the time period to the remote storage away from the vehicle.

6. The vehicle monitoring system of claim 5 wherein:
the captured images comprises a video, the video having a series of image frames captured during the time period; and
synchronizing the captured images and the performance metrics further comprises embedding the performance metrics captured for the time period in the image frames of the video captured during the time period.

7. The vehicle monitoring system of claim 5 wherein:
the captured images comprises a video, the video having a series of image frames captured during the time period; and
synchronizing the captured images and the performance metrics further comprises embedding a reference to the performance metrics captured for the time period in the image frames of the video captured during the time period.

8. The vehicle monitoring system of claim 5 wherein:
the captured images comprises a video, the video having a series of image frames captured during the time period; and
synchronizing the captured images and the performance metrics further comprises associating the performance metrics captured for the time period with the image frames of the video captured during the time period.

9. The vehicle monitoring system of claim 5 wherein transmitting the synchronized captured images and the performance metrics for the time period to the remote storage away from the vehicle further comprises:
attempting to establish a data communications channel between the data processing system and a remote computing device, the remote computing device comprising the remote storage;
determining whether the data communications channel is available for communications;
if the data communications channel is available for communications, transmitting the synchronized captured images and the performance metrics to the remote computing device for storage in the remote storage;
if the data communications channel is not available for communications, buffering for later transmission the synchronized captured images and the performance metrics until the data communications channel is available for communications.

10. The vehicle monitoring system of claim 5 wherein transmitting the synchronized captured images and the performance metrics for the time period to the remote storage away from the vehicle further comprises streaming the synchronized captured images and the performance metrics for the time period to the remote storage away from the vehicle as the synchronized captured images and the performance metrics for the time period are received from the cameras.

11. The vehicle monitoring system of claim 5 wherein transmitting the synchronized captured images and the performance metrics for the time period to the remote storage away from the vehicle further comprises transmitting the synchronized captured images and the performance metrics for the time period to remote storage away from the vehicle concurrently with the recording of the synchronized captured images and the performance metrics for the time period in the non-volatile memory.

12. The vehicle monitoring system of claim 1 wherein transmitting the captured images to remote storage away from the vehicle further comprises:
establishing a data communications channel with a portable computing device, the portable computing device comprising remote storage; and
transmitting the captured images to the portable computing device for display to a user.

13. The vehicle monitoring system of claim 1 wherein the at least one processor, the at least one memory, and the at least one transmitter of the data processing system are operatively connected together for:
receiving an activation signal from a remote computing device; and
activating the cameras in response to receiving the activation signal.

14. The vehicle monitoring system of claim 1 wherein:
the vehicle is repaired at a service facility;
the cameras capture images of workers of the service facility working on the vehicle;
transmitting the captured images to remote storage away from the vehicle further comprises transmitting the captured images to a portable computing device for display to a user.

15. A vehicle monitoring system for use with a vehicle, the vehicle having cargo and non-cargo regions, the non-cargo regions comprising an engine compartment and an undercarriage, the vehicle monitoring system comprising:
one or more cameras configured in the non-cargo regions to capture images of the non-cargo regions;
one or more sensors configured in the vehicle for capturing performance metrics of the vehicle;
a data processing system mounted to the vehicle, the data processing system operatively connected to the cameras and the sensors, the data processing system comprising at least one processor, at least one memory, and at least one transmitter operatively connected together for:
receiving captured images from the cameras for a time period;
receiving performance metrics from the sensors for the time period;
synchronizing the captured images and the performance metrics; and
administering the synchronized captured images and performance metrics in dependence upon administration criteria.

16. The system of claim 15 wherein administering the synchronized captured images and performance metrics in dependence upon administration criteria further comprises transmitting the synchronized captured images and performance metrics to remote storage away from the vehicle.

17. The system of claim 15 wherein administering the synchronized captured images and performance metrics in dependence upon administration criteria further comprises:
recording the synchronized captured images and performance metrics in non-volatile memory configured in the vehicle;
transmitting the synchronized captured images and performance metrics to remote storage away from the vehicle.

18. A vehicle monitoring system for use with a vehicle, the vehicle having cargo and non-cargo regions, the non-cargo regions comprising an engine compartment and an undercarriage, the vehicle monitoring system comprising:
one or more cameras configured in the non-cargo regions to capture images of the non-cargo regions, the cameras recording the captured images in non-volatile memory configured in the cameras;
a data processing system mounted to the vehicle, the data processing system operatively connected to the cameras, the data processing system comprising at least one processor, at least one memory, and at least one transmitter operatively connected together for:
receiving captured images from the cameras;
transmitting the captured images to remote storage away from the vehicle.

19. The vehicle monitoring system of claim 18 wherein:
the vehicle further comprises one or more sensors configured in the vehicle for capturing performance metrics of the vehicle for a time period;
receiving captured images from the cameras further comprises receiving captured images from the cameras during the time period;
the at least one processor, the at least one memory, and the at least one transmitter of the data processing system are operatively connected together for:
synchronizing the captured images and the performance metrics for the time period; and
recording the synchronized captured images and the performance metrics for the time period; and
transmitting the captured images to remote storage away from the vehicle further comprises transmitting the synchronized captured images and the performance metrics for the time period to the remote storage away from the vehicle.

20. A vehicle monitoring system for use with a vehicle, the vehicle having a cargo and non-cargo regions, the non-cargo regions comprising an engine compartment and an undercarriage, the vehicle monitoring system comprising:
one or more cameras configured in the non-cargo regions to capture images of the non-cargo regions;
one or more microphones configured in the non-cargo regions to capture audio of the non-cargo regions;
a data processing system mounted to the vehicle, the data processing system operatively connected to the cameras and the microphones, the data processing system comprising at least one processor, at least one memory, and at least one transmitter operatively connected together for:
receiving captured images and audio from the cameras;
recording the captured images and audio in non-volatile memory configured in the vehicle;
transmitting the captured images and audio to remote storage away from the vehicle.

21. The vehicle monitoring system of claim 20 wherein:
the data processing system comprising at least one processor, at least one memory, and at least one transmitter is operatively connected together for analyzing the captured images and the captured audio using analysis rules;
recording the captured images and audio in non-volatile memory configured in the vehicle further comprises recording captured images and audio in non-volatile memory configured in the vehicle in dependence upon the analysis of the captured images and the captured audio; and
transmitting the captured images and audio to remote storage away from the vehicle further comprises transmitting the captured images and audio to remote storage away from the vehicle in dependence upon the analysis of the captured images and the captured audio.
